(19) United States
(12) Patent Application Publication
(10) Pub. No.: US 2015/0032906 A1
(43) Pub. Date: Jan. 29, 2015

(54) APPARATUS AND METHOD FOR ASSIGNING IP ADDRESS IN COMMUNICATION SYSTEM

(71) Applicant: Samsung Electronics Co., Ltd., Suwon-si (KR)

(72) Inventors: Ki-Suk KWEON, Suwon-si (KR); Alper YEGIN, Istanbul (TR); Jung-Shin PARK, Seoul (KR); Jin-Sung LEE, Suwon-si (KR)

(21) Appl. No.: 14/340,995

(22) Filed: Jul. 25, 2014

Related U.S. Application Data
(60) Provisional application No. 61/858,420, filed on Jul. 25, 2013.

(30) Foreign Application Priority Data
Jul. 18, 2014 (KR) 10-2014-0091006

(51) Int. Cl. H04L 29/12

(52) U.S. Cl. CPC H04L 61/2007; H04L 61/6068
USPC 709/245

(57) ABSTRACT

A method for selecting a source address in a host electronic device is provided. The method includes determining an address type to use in communication of an application which is being executed, selecting a source address based on the determined address type, and setting the selected source address as a source Internet Protocol (IP) address for a transmission packet of the application which is being executed.

### CROSS-REFERENCE TO RELATED APPLICATION(S)

This application claims the benefit under 35 U.S.C. §119(e) of a U.S. provisional application filed on Jul. 25, 2013 in the U.S. Patent and Trademark Office and assigned Ser. No. 61/858,420 and under 35 U.S.C. §119(a) of a Korean patent application filed on Jul. 18, 2014 in the Korean Intellectual Property Office and assigned Serial number 10-2014-0091006, the entire disclosure of each of which is hereby incorporated by reference.

### TECHNICAL FIELD

The present disclosure relates to a method and an apparatus for assigning an Internet Protocol (IP) address in a communication system.

### BACKGROUND

Generally, a host electronic device supporting Internet protocol is assigned with an Internet Protocol (IP) address when accessing a network and performs communication by using the assigned IP address. Recently, a technique has been researched, in which the host electronic device is assigned with a plurality of IP addresses and selects an IP address suitable for communication among the plurality of IP addresses. For example, a technique has been discussed, in which, when an application which is being executed attempts to communicate with a remote host electronic device, the host electronic device selects a source IP address based on a source address selection algorithm.

FIG. 1 illustrates a method for selecting an IP address in a host electronic device supporting Internet Protocol version 6 (IPv6) according to the related art.

Referring to FIG. 1, the host electronic device uses a source address selection algorithm including eight rules 120 defined in RFC 6274 in order to select an IP address. For example, the source address selection algorithm of the host electronic device selects (130) a source IP address based on the eight rules 120, by using a destination IP address 100 and a plurality of source addresses 110 as an input. In this case, the eight rules include a first rule of selecting the same address as a destination address, a second rule of selecting an appropriate range, a third rule of evading an unused address, a fourth rule of selecting a home address, a fifth rule of selecting an outgoing interface, a sixth rule of selecting a matched label, a seventh rule of selecting a temporary address, and an eighth rule of using the longest prefix. The source address selection algorithm performs the eight rules one at a time sequentially in order to a source IP address and, when a source IP address is selected according to a specific rule, the other rules are not performed.

The fourth rule included in the source address selection algorithm is associated with mobility management and is a rule of selecting a home address instead of Care of Address (CoA). However, the CoA and the home address are clearly not discriminated from each other. For example, the IP address may be classified into an IP address anchored to a home network, an IP address anchored to an access network, and an IP address non-anchored to any network. In this case, the IP address anchored to the home network corresponds to a home address, and the IP address non-anchored to any network corresponds to the CoA. However, the IP address anchored to an access network does not correspond to a home address or a CoA. Therefore, when using an existing source address selection algorithm, it is possible to hardly consider the IP address anchored to an access network. Furthermore, the host electronic device may require a temporal communication session according to an application which is being executed or may require a long-maintained communication session. However, the existing source address selection algorithm does not consider communication characteristics according to an application. Accordingly, there may be a decrease in communication efficiently.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for selecting a source Internet Protocol (IP) address in a communication system.

Another aspect of the present disclosure is to provide a method and an apparatus for selecting a source IP address based on application characteristics in a host electronic device.

Another aspect of the present disclosure is to provide a method and an apparatus for selecting a source IP address based on destination port and/or protocol information in a host electronic device.

Another aspect of the present disclosure is to provide a method and an apparatus for selecting a source IP address based on a destination server name corresponding to a destination address in a host electronic device.

Another aspect of the present disclosure is to provide a method and an apparatus for determining an IP address type based on at least one of application characteristics, a destination port, a protocol and a destination server name and selecting a source IP address corresponding to the determined IP address type in a host electronic device.

In accordance with an aspect of the present disclosure, a method for selecting a source address in a host electronic device is provided. The method includes determining an address type to use in communication of an application which is being executed, selecting a source address based on the determined address type, and setting the selected source address as a source IP address for a transmission packet of the application which is being executed.

In accordance with another aspect of the present disclosure, an apparatus for selecting a source address in a host electronic device is provided. The apparatus includes an application unit configured to execute at least one application, and a source address selection unit configured to determine an address type to use in communication of the application which is being executed, to select a source address based on the determined address type, and to set the selected source address as a source IP address for a transmission packet of the application which is being application.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will become more apparent from the following description taken in conjunction with the accompanying drawings, in which:

FIG. 1 illustrates a method for selecting an Internet Protocol (IP) address in a host electronic device supporting Internet Protocol version 6 (IPv6) according to the related art;

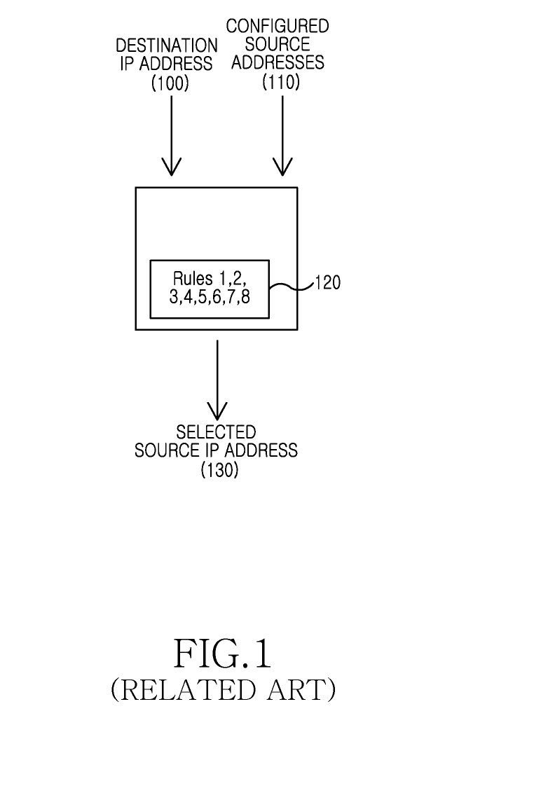

FIG. 2 is a diagram illustrating a block configuration of a host electronic device according to an embodiment of the present disclosure;

FIG. 3 is a diagram illustrating a method for operating a source address selection algorithm according to an embodiment of the present disclosure;

FIG. 4A is a diagram illustrating a table representing a mapping relationship between a destination port/protocol and an IP address type according to an embodiment of the present disclosure;

FIG. 4B is a diagram illustrating a table representing a mapping relationship between an application and an IP address type according to an embodiment of the present disclosure;

FIG. 4C is a diagram illustrating a table representing a mapping relationship between a destination server name and an IP address type according to an embodiment of the present disclosure; and

FIG. 5 illustrates a process of selecting a source address in a host electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions or constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

In describing the components of the present embodiments, there may be terms used, such as first, second, A, B, (a), (b), and the like. These are solely for the purpose of differentiating one component from the other but not to imply or suggest the substances, order or sequence of the components. If a component were described as “connected”, “coupled”, or “linked” to another component, that may indicate that the components are not only directly “connected”, “coupled”, or “linked” but also are indirectly “connected”, “coupled”, or “linked” via a third component.

In the following description, a host electronic device refers to an electronic device that is connected to an Internet network and communicates with other Internet host electronic devices. The host electronic device may be an electronic device capable of connecting to an Internet network, such as, a User Equipment (UE), a Mobile Terminal (MT), a User Terminal (UT), a Subscriber Station (SS), a wireless device, a Personal Digital Assistant (PDA), a wireless modem, a handheld device, and the like.

A method for selecting a source Internet Protocol (IP) address by the host electronic device in a communication system will be described below. Herein, a type of an IP address associated with IP layer mobility management is classified into three types. A first type is an IP address anchored to a home network, a second type is an IP address anchored to an access network, and a third type is an IP address non-anchored to any network. In various embodiments of the present disclosure, the host electronic device may perform a first step of selecting an IP address type and a second step of selecting a source IP address corresponding to the selected IP address type, in order for a source IP address to use in communication of an application which is being executed. Herein, although the terms “address” and “IP address” both are used, they are intended to refer to the same meaning.

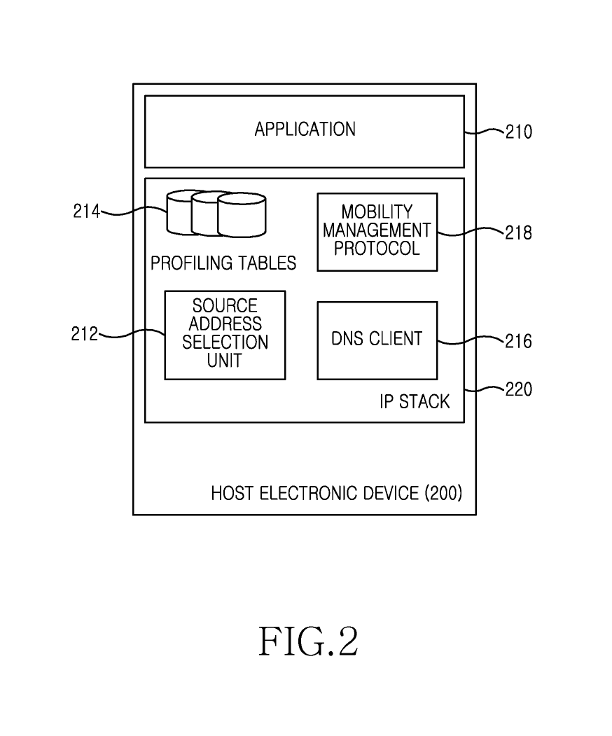

FIG. 2 is a diagram illustrating a block configuration of a host electronic device according to an embodiment of the present disclosure.

Referring to FIG. 2, a host electronic device 200 includes an application 210 and an IP stack 220. According to an embodiment of the present disclosure, the IP stack 220 may include a source address selection unit 212, profiling tables 214, a Domain Name System (DNS) client 216 and a mobility management protocol 218. The block configuration of the host electronic device 200 is a schematic configuration for performing functions. Therefore, the host electronic device 200 may include additional block configurations (for example, a processor, a bus, a memory, an input/output interface, a display, a communication interface, or the like) according to various embodiments of the present disclosure.

The application 210 includes at least one application for providing a service to a user. The application 210 may be executed under the control of a processor (not illustrated) of the host electronic device 200 based on a user input or a certain manner. According to an embodiment of the present disclosure, the application 210 may provide identifier information of an application that is driven (or executed) to the IP stack 220. Herein, identifier information of an application is intended to include a platform-dedicated (for example, an operating system-dedicated) identifier. For example, a specific application has a specific identifier enabling the specific application to be discriminated from other applications in a specific operating system. The application 210 may provide a data packet for communicating with a counterpart host electronic device (or a remote host electronic device) by the executed application to the IP stack 220. According to various embodiments of the present disclosure, the application 210 may include an instant messenger application, a Short Message Service (SMS)/Multimedia Message Service (MMS) application, an email application, a Social Network Service (SNS) application, and the like, which use Internet network connection when being executed.

The IP stack 220 may perform a function for setting a source IP address and a destination IP address for a data packet and performing routing, for each application or for each flow in order to transmit the data packet to a destination. For example, the IP stack 220 includes a source address selection unit 212 to determine a type of an IP address to use in application communication, search for a source address corresponding to the determined IP address type among previously-configured source addresses, and select the found source address as a source IP address.

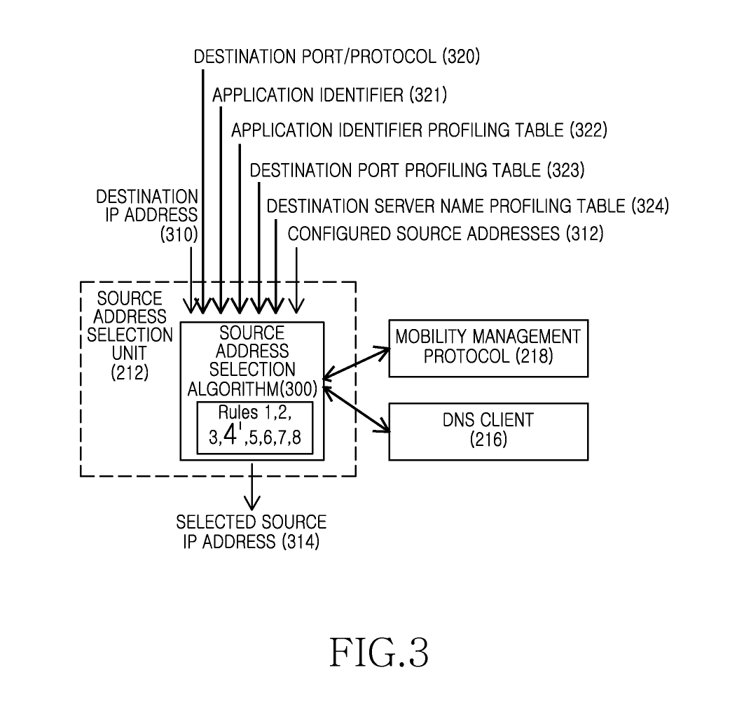

FIG. 3 is a diagram illustrating a method for operating a source address selection algorithm according to an embodiment of the present disclosure.

Referring to FIG. 3, the source address selection unit 212 may receive a destination port/protocol 320, an application identifier 321, and configured source addresses 312, and may additionally receive inputs from an application identifier profiling table 322, a destination port/protocol profiling table 323, and a destination server name profiling table 324 as illustrated in FIG. 3.

According to an embodiment of the present disclosure, the source address selection unit 212 may select a source IP address 314 by using a source address selection algorithm 300, the fourth rule of which is changed among the eight rules 120 defined in RFC 6274. For example, the source address selection unit 212 may determine an IP address type for selecting a source IP address 314 based on a destination IP address 310, the destination port/protocol 320, the application identifier 321, and the inputs provided from the plurality of profiling tables 322 to 324, and select a source address corresponding to the determined IP address type among the configured source addresses 312, according to the changed fourth rule of the source address selection algorithm 300. In this case, determination of the IP address type is for use of a source IP address suitable for characteristics of a session requested by an application which is being executed. For example, when it is assumed that a session requested by an application is a short-lived communication session (for example, instant messenger messaging or DNS request), use of a third type of IP address may be more effective than use of a first type of IP address.

As another example, when it is assumed that a session requested by an application is a HyperText Transfer Protocol (HTTP) session that is maintained for a certain time, use of a second type of IP address may be most effective. As another example, when it is assumed that a session requested by an application is a session that is maintained for a long time, use of the first type of IP address may be most effective. In this case, when the second type of IP address is used for the session which is maintained for a long time, routing is inefficiently performed. When the third type of IP address is used for the session which is maintained for a long time, the session may be broken. Therefore, the source address selection unit 212 may determine an IP address type based on the destination IP address 310, the destination port/protocol 320, the application identifier 321, and inputs from the plurality of profiling tables 214 and 322 to 324 according to the changed forth rule, and determine a source address corresponding to the determined IP address type as a source IP address to be included in a data packet of a relevant application.

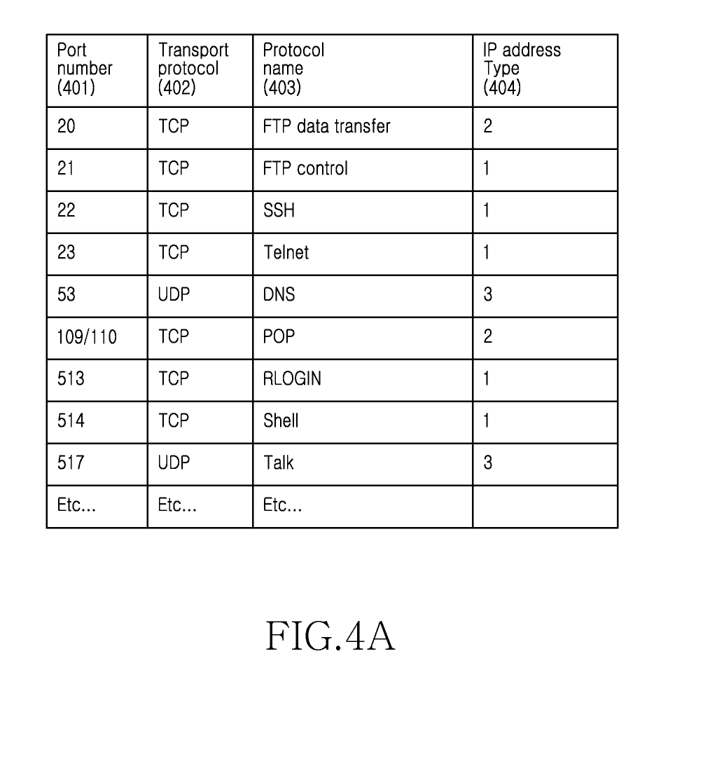

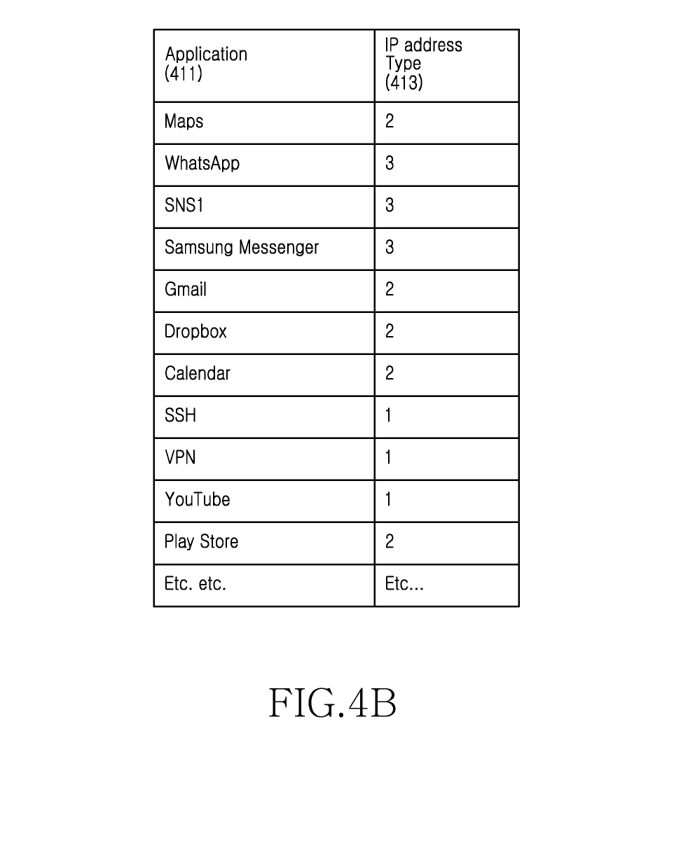

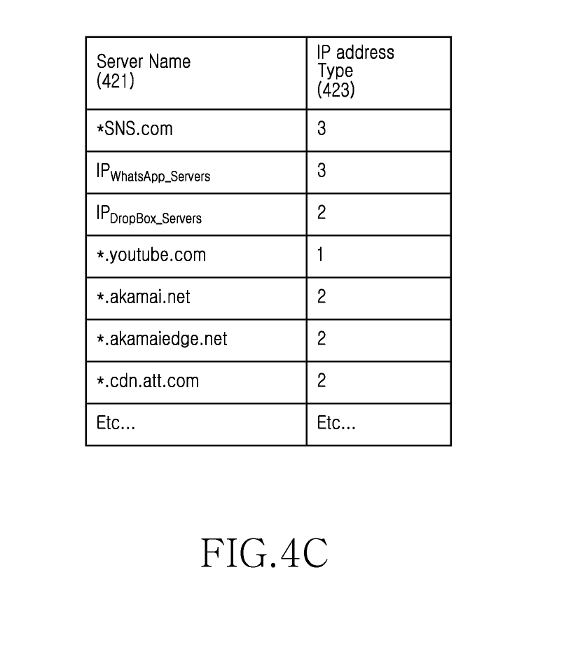

Specifically, the source address selection unit 212 may receive transport layer protocol information and a destination port number, which are to use in communication intended by an application which is being executed. In addition, the source address selection unit 212 may search for an IP address type corresponding to the destination port number and the transport layer protocol information from the destination port/protocol profiling table 323 and select the IP address type. For example, the destination port/protocol profiling table 323 may be configured such that each of IP address types 404 corresponds to a destination port number 401, a transport layer protocol, and a transport layer protocol name 403 as illustrated in FIG. 4A.

FIG. 4A is a diagram illustrating a table representing a mapping relationship between a destination port/protocol and an IP address type according to an embodiment of the present disclosure.

Referring to FIG. 4A, the destination port number input to the source address selection unit 212 is “21” and the transport layer protocol information input to the source address selection unit 212 is “TCP” and “FTP control”, the source address selection unit 212 may select a first address type. In another embodiment of the present disclosure, the destination port number input to the source address selection unit 212 is “53” and the transport layer protocol information input to the source address selection unit 212 is “UDP” and “DNS”, the source address selection unit 212 may select a third address type. In another embodiment of the present disclosure, when the destination port number and the transport layer protocol information, which are input to the source address selection unit 212, do not exist in the destination port/protocol profiling table 323, the source address selection unit 212 may attempt to select an IP address type based on a destination server name or an application identifier.

In addition, the source address selection unit 212 may be provided with application identifier information by an application which is being executed. Thereafter, the source address selection unit 212 may search for an IP address type corresponding to the application identifier information from the application identifier profiling table 322, and select the IP address type. For example, the application identifier profiling table 322 may be configured such that IP address types 413 correspond to application identifiers 411 respectively as illustrated in FIG. 4B.

FIG. 4B is a diagram illustrating a table representing a mapping relationship between an application and an IP address type according to an embodiment of the present disclosure.

Referring to FIG. 4B, when the application identifier input to the source address selection unit 212 is “SNS1”, the source address selection unit 212 may select the third address type. As another embodiment of the present disclosure, when the application identifier input to the source address selection unit 212 is “Calendar”, the source address selection unit 212 may select the second address type. In another embodiment, when the input application identifier do not exist in the application identifier profiling table 322, the source address selection unit 212 may attempt to select an IP address type based on the destination server name or destination port number/transport layer protocol information.

In addition, the source address selection unit 212 is provided with a destination IP address 312 and acquires a server name (for example, domain) corresponding to the destination IP address 312 through the DNS client 216. Thereafter, the source address selection unit 212 may search for and select an IP address type corresponding to the server name from the destination server name profiling table 324. For example, the destination server name profiling table 324 may be configured such that IP address types 423 correspond to server names 421 respectively as illustrated in FIG. 4C.

FIG. 4C is a diagram illustrating a table representing a mapping relationship between a destination server name and an IP address type according to an embodiment of the present disclosure.

Referring to FIG. 4C, when the server name input to the source address selection unit 212 is “samsung.com”, the source address selection unit 212 may select the third address type. As another embodiment of the present disclosure, when the server name input to the source address selection unit 212 is “akamai.net”, the source address selection unit 212 may select the second address type. In another embodiment of the present disclosure, when the input server name do not exist in the server name profiling table 324, the source address selection unit 212 may attempt to select an IP address type based on an application identifier or destination port number/transport layer protocol information.

When the source address selection unit 212 does not determine an IP address type in spite of searching the plurality of profiling tables 214 by using the destination port number/transport layer protocol information, the destination server name, and the application identifiers, the source address selection unit 212 may select a preset IP address type. According to an embodiment of the present disclosure, the preset IP address type may be the first address type.

After determination of the IP address type, the source address selection unit 212 may determine a source address corresponding to the determined IP address type among the source addresses 312 which are previously configured and are input as a source IP address to be included in a data packet of a relevant application. When there is a single source address corresponding to the determined IP address type among the configured source addresses 312, the source address selection unit 212 determines the single source address as a source IP address to be included in a data packet of the host electronic device 200. On the contrary, when there are five source addresses corresponding to the determined IP address type among the configured source addresses 312, the source address selection unit 212 may determine a source IP address to be included in the data packet of the host electronic device 200 based on the plurality of source addresses according to subsequent rules (for example, fifth to eighth rules). As another example, when there is no source address corresponding to the determined IP address type among the configured source addresses 312, the source address selection unit 212 may trigger the mobility management protocol 218 and dynamically configure a source IP address corresponding to the determined IP address type.

The profiling tables 214 include tables representing a relationship between a verity of information and an IP address type. The profiling tables 214 may include the destination port/protocol profiling table 323 representing a mapping relationship among the destination port number 401, the transport layer protocol information 402 and 403, and the IP address type 404 as illustrated in FIG. 4A. The profiling tables 214 may include the application identifier profiling table 322 representing a mapping relationship between the application identifier 411 and the IP address type 413 as illustrated in FIG. 4B. The profiling tables 214 may include the server name profiling table 324 representing a mapping relationship between the server name corresponding to a destination IP address and the IP address type 423 as illustrated in FIG. 4C. The profiling tables 214 as described above may be provided statically or dynamically. In addition, the profiling tables 214 may be updated periodically or according to generation of a specific event. For example, the host electronic device 200 may receive at least one profiling table 214 from a network through the Dynamic Host Configuration Protocol (DHCP) or the Open Mobile Alliance (OMA) device management protocol.

The DNS client 216 converts (translates) a destination IP address into a destination server name (for example, a domain) and provides the destination server name to the source address selection unit 212 according to a request from the source address selection unit 212 of the IP stack 220. According to an embodiment of the present disclosure, the destination server name obtained from the destination IP address may be used to search for a relevant IP address type from the server name profiling table 323.

The mobility management protocol 218 is triggered by the control of the source address selection unit 212 of the IP stack 220 and is used to configure a required IP address. For example, the mobility management protocol 218 may be used to configure an IP address corresponding to the IP address type selected by the source address selection unit 212. The mobility management protocol 218 may include, for example, a mobile IP protocol and a General Packet Radio Service (GPRS) Tunneling Protocol (GTP).

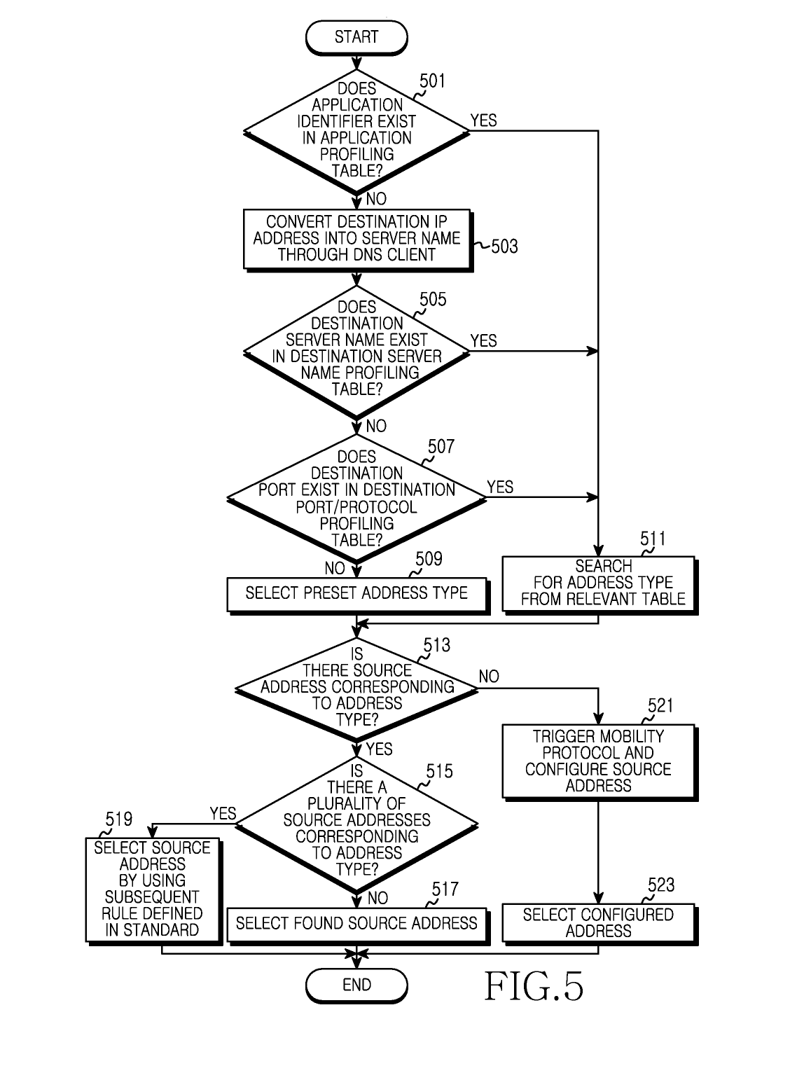

FIG. 5 illustrates a process of selecting a source address in a host electronic device according to an embodiment of the present disclosure.

Referring to FIG. 5, the host electronic device 200 determines whether the identifier of an application which is being executed exists in an application profiling table in operation 501. For example, the host electronic device 200 determines whether the identifier of the application exists in a pre-stored application profiling table in order to select an IP address for a data packet generated by the application which is being executed so as to communicate with a counterpart host electronic device. The application profiling table refers to a table representing a mapping relationship between the application identifier 411 and the IP address type 413 as illustrated in FIG. 4B.

When the identifier of the application which is being executed exists in the application profiling table, the host electronic device 200 searches for an IP address type mapped to the identifier of the application from the application profiling table in operation 511. For example, when the identifier of the application which is being executed is “SSH”, the host electronic device 200 searches for an IP address type mapped to “SSH” from the application profiling table as illustrated in FIG. 4B and identifies that the found IP address type is the first address type.

On the contrary, when the identifier of the application which is being executed does not exist in the application profiling table, the host electronic device 200 converts a destination IP address into a destination server name through the DNS client in operation 503. For example, the host electronic device 200 may acquire the server name from the destination IP address of a transmission data packet through the DNS client. When the destination server name corresponding to the destination IP address of the transmission data packet is known in advance, the host electronic device 200, the operation 503 may be omitted.

The host electronic device 200 determines whether the destination server name exists in a destination server name profiling table in operation 505. The destination server name profiling table refers to a table representing a mapping relation between the server name 421 and the IP address type 423 as illustrated in FIG. 4C.

When the destination server name exists in the destination server name profiling table, the host electronic device 200 searches for an IP address type mapped to the destination server name from the destination server name proofing table in operation 511. For example, when the destination server name is “*SNS.com” based on the destination IP address of a data packet to be transmitted, the host electronic device 200 may search for the IP address type mapped to “*SNS.com” from the destination server name profiling table as illustrated in FIG. 4C, and identify that the found IP address type is the third address type.

On the contrary, when the destination server name does not exist in the destination server name profiling table, the host electronic device 200 determines whether a destination port exists in a destination port/protocol profiling table in operation 507. The destination/protocol profiling table may be a table representing a mapping relationship among the destination port number 401, the transport layer protocol 402, the transport layer protocol name 403, and the IP address type 404 as illustrated in FIG. 4A. In this case, the transport layer protocol 402 indicates whether a transport layer protocol type is the User Datagram Protocol (UDP), the Transmission Control Protocol (TCP), or the Stream Control Transmission Protocol (SCTP).

When the destination port exists in the destination port/protocol profiling table, the host electronic device 200 searches for an IP address type mapped to the destination port from the destination port/protocol profiling table in operation 511. For example, when the destination port number of the data packet to be transmitted is “53”, the host electronic device 200 may search for an IP address type mapped to the port number “53” from the destination port/protocol profiling table as illustrated in FIG. 4A, and identify that the found IP address type is the third address type. According to an embodiment of the present disclosure, the host electronic device 200 may search for an IP address type by using the destination port number 401 alone or may search for an IP address type by additionally using the transport layer protocol 402 and the transport layer protocol name 403. As an example, the host electronic device 200 may search for an IP address type corresponding to all the destination port number 401, the transport layer protocol 402, and the transport layer protocol name 403.

On the contrary, when the destination server name does not exist in the server name profiling table, the host electronic device 200 selects a preset address type in operation 509. For example, since the host electronic device 200 fails to search for an IP address type corresponding to information on an application which is being executed, the destination IP address of transmission data, the port number, and transport layer protocol information, the host electronic device 200 may select the preset address type. The preset address type may be set to one of the first address type, the second address type, and the third address type. The preset address type may be set fixedly or may be changed according to at least one of a user, a system operator, and a system operating method.

Thereafter, the host electronic device 200 determines whether there is a source address corresponding to the selected address type among pre-configured source addresses in operation 513. In this case, the preconfigured source addresses may be preconfigured by a mobility protocol. The host electronic device 200 may determine address types of respective source addresses based on a preset method or address values of the source addresses.

When there is no source address corresponding to an address type selected among the preconfigured source addresses, the host electronic device 200 triggers the mobility protocol to configure a source address corresponding to the selected address type in operation 521. The host electronic device 200 selects the configured source address as a source IP address of data to be transmitted in operation 523 and ends the process.

On the contrary, when there is a source address corresponding to the address type selected among the preconfigured source addresses, the host electronic device 200 determines whether there are a plurality of source addresses corresponding to the selected source type in operation 515.

When there are a plurality of source addresses corresponding to the selected source type among the preconfigured source addresses, the host electronic device 200 selects a source IP address of data to be transmitted among the plurality of source addresses by using subsequent rules of the source address selection algorithm in operation 519 and ends the process. For example, the source address selection algorithm 300 has the fourth rule which is changed among the eight rules defined in RFC 6274. Thereafter, when the host electronic device 200 searches for a plurality of source addresses corresponding to a specific address type based on the fourth rule, the host electronic device 200 may select the found plurality of source addresses as candidate source addresses and then select one source IP address among the plurality of candidate source addresses based on the fifth to eighth rules which are performed subsequent to the fourth rule.

On the contrary, when there are no plurality of source addresses corresponding to the selected source type among the preconfigured source addresses, the host electronic device 200 selects a found IP address in operation 517 and ends the process. When there is a single source address corresponding to the address type selected among the preconfigured source addresses, the host electronic device 200 selects the single source address corresponding to the selected address type as a source IP address of data to be transmitted in operation 517 and then ends the process.

In the above-described embodiment, the host electronic device first determines whether IP address type information corresponding to an application identifier is stored therein in operation 501 and thereafter determines whether IP address type information corresponding to a destination server name is stored therein in operation 505. Finally, the host electronic device determines whether IP address type information corresponding to a destination port is stored therein in operation 507. However, the above-described determination orders may be changed in the host electronic device according to various embodiments. For example, the host electronic device may first perform the operation 507 of determining whether IP address type information corresponding to a destination port is stored therein and then perform the operation 501 and the operation 505. As another example, the host electronic device may first perform the operation 505 of determining whether IP address type information corresponding to a destination server name is stored therein and then perform the operation 501 and the operation 507.

According to the various embodiments of the present disclosure, the host electronic device determines an IP address type based on at least one of application characteristics, a destination port, a protocol, and a destination server name and selects a source IP address corresponding to the determined IP address type, thereby using the source IP address having the address type required by an application which is being executed in the host electronic device and improving communication efficiency.

The operations according to various embodiments of the present disclosure may be implemented by a single control unit. In this case, program commands for performing operations implemented by various computers may be recorded in a computer-readable medium. The computer-readable recording medium may include program commands, data files, and data structures in singularity or in combination. The program commands may be those that are especially designed and configured for the present disclosure, or may be those that are publicly known and available to those skilled in the art. Examples of the computer-readable recording medium include magnetic media, such as hard disks, floppy disks and magnetic tapes, optical media such, as Compact Disc-Read Only Memories (CD-ROMs) and Digital Video Discs (DVDs), magneto-optical media, such as floptical disks, and hardware devices, such as ROMs, Random Access Memories (RAMs) and flash memories that are especially configured to store and execute program commands. Examples of the program commands include machine language codes created by a compiler, and high-level language codes that can be executed by a computer by using an interpreter. When all or some of a base station or a relay described in the present disclosure is implemented by a computer program, a computer-readable recording medium storing the computer program is also included in the present disclosure. Therefore, the scope of the disclosure is defined not by the detailed description of the disclosure but by the appended claims, and all differences within the scope will be construed as being included in the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for selecting a source address in a host electronic device, the method comprising:
determining an address type to use in communication of an application which is being executed;
selecting a source address based on the determined address type; and
setting the selected source address as a source Internet Protocol (IP) address for a transmission packet of the application which is being executed.

2. The method of claim 1, wherein the address type comprises at least one of an IP address type anchored to a home network, an IP address type anchored to an access network, and an IP address type non-anchored to any network.

3. The method of claim 1, wherein the determining of the address type to use in communication of the application which is being executed comprises determining the address type based on an identifier of the application which is being executed.

4. The method of claim 1, wherein the determining of the address type to use in communication of the application which is being executed comprises determining the address type based on a destination IP address for transmission data of the application which is being executed.

5. The method of claim 4, wherein the determining of the address type based on the destination IP address comprises:
acquiring a destination server name corresponding to the destination IP address; and
determining the address type based on the acquired server name.

6. The method of claim 1, wherein the determining of the address type to use in communication of the application which is being executed comprises determining the address type based on at least one of a destination port number for transmission data of the application which is being executed, a transport layer protocol type, and a transport layer protocol name.

7. The method of claim 1, wherein the selecting of the source address based on the determined address type comprises:
determining whether there is a source address corresponding to the determined address type among preconfigured source addresses;
triggering, if there is no source address corresponding to the determined address type among the preconfigured source addresses, a mobility protocol and configuring a source address corresponding to the determined address type; and
selecting the configured source address.

8. The method of claim 7, further comprising:
determining, if there is a source address corresponding to the determined address type among the preconfigured source addresses, whether there are a plurality of source addresses corresponding to the determined address type; and
selecting, if there is a single source address corresponding to the determined address type, the single source address.

9. The method of claim 8, further comprising:
selecting, if there are a plurality of source addresses corresponding to the determined address type, the plurality of source addresses as candidate source addresses; and
selecting one of the candidate source addresses.

10. The method of claim 1, wherein the determining of the address type to use in communication of the application which is being executed comprises:
searching for address type information corresponding to at least one of an identifier of the application which is being executed, a destination IP address for transmission data of the application which is being executed, a destination port number, a transport layer protocol type, and a transport layer protocol name; and
determining, if the address type information corresponding to the at least one is not found, a preset address type.

11. An apparatus for selecting a source address in a host electronic device, the apparatus comprising:
an application unit configured to execute at least one application; and
a source address selection unit configured to determine an address type to use in communication of the application which is being executed, to select a source address based on the determined address type, and to set the selected source address as a source Internet Protocol (IP) address for a transmission packet of the application which is being application.

12. The apparatus of claim 11, wherein the address type comprises at least one of an IP address type anchored to a home network, an Internet protocol (IP) address type anchored to an access network, and an IP address type non-anchored to any network.

13. The apparatus of claim 11, wherein the source address selection unit is further configured to determine the address type based on an identifier of the application which is being executed.

14. The apparatus of claim 11, wherein the source address selection unit is further configured to determine the address type based on a destination IP address of transmission data of the application which is being executed.

15. The apparatus of claim 14, wherein the source address selection unit is further configured to acquire a destination server name corresponding to the destination IP address and to determine the address type based on the acquired server name.

16. The apparatus of claim 11, wherein the source address selection unit is further configured to determine the address type based on at least one of a destination port number for transmission data of the application that is being executed, a transport layer protocol type, and a transport layer protocol name.

17. The apparatus of claim 11, wherein the source address selection unit is further configured to determine whether there is a source address corresponding to the determined address type among preconfigured source addresses, if there is no source address corresponding to the determined address type among the preconfigured source addresses, to trigger a mobility protocol, to configure a source address corresponding to the determined address type, and to select the configured source address.

18. The apparatus of claim 17, wherein, if there is a source address corresponding to the determined address type among the preconfigured source addresses, the source address selection unit is further configured to determine whether there are a plurality of source addresses corresponding to the determined address type and, if there is a single source address corresponding to the determined address type, to select the single source address.

19. The apparatus of claim 18, wherein, if there are a plurality of source addresses corresponding to the determined address type, the source address selection unit is further configured to select the plurality of source addresses as candidate source addresses, and to select one of the candidate source addresses.

20. The apparatus of claim 11, wherein the source address selection unit is further configured to search for address type information corresponding to at least one of an identifier of the application which is being executed, a destination IP address for transmission data of the application which is being executed, a destination port number, a transport layer protocol type, and a transport layer protocol name and, if the address type information corresponding to the at least one is not found, to determine a preset address type.
